(19) United States
(12) Patent Application Publication
(10) Pub. No.: US 2024/0256793 A1
(43) Pub. Date: Aug. 1, 2024

(54) METHODS AND SYSTEMS FOR GENERATING TEXT WITH TONE OR DICTION CORRESPONDING TO STYLISTIC ATTRIBUTES OF IMAGES

(71) Applicant: Shopify Inc., Ottawa (CA)

(72) Inventor: Russ MASCHMEYER, Berkeley, CA (US)

(21) Appl. No.: 18/180,566

(22) Filed: Mar. 8, 2023

Related U.S. Application Data
(60) Provisional application No. 63/482,496, filed on Jan. 31, 2023.
(60) Provisional application No. 63/483,731, filed on Feb. 7, 2023.

(51) Int. Cl. G06F 40/40; G06F 40/284; G06F 40/30; G06V 10/40; G06V 10/82; G06V 20/70

(52) U.S. Cl. CPC G06F 40/40; G06F 40/284; G06F 40/30; G06V 10/40; G06V 10/82; G06V 20/70

(57) ABSTRACT

Methods and systems for prompting a large language model (LLM) to generate a stylistic description of an image are disclosed. One or more visual attributes are extracted from an image using a first trained machine learning model. The visual attributes are mapped to one or more emotion attributes using a second trained machine learning model. A LLM prompt is generated based on the one or more emotion attributes and provided to the LLM. A generated description of the image is obtained from the LLM and displayed with the image.

### CROSS-REFERENCE TO RELATED APPLICATIONS

The present disclosure claims priority from U.S. provisional patent No. 63/482,496, filed Jan. 31, 2023, entitled “GENERATION OF TEXT WITH TONE OR DICTION CORRESPONDING TO STYLISTIC ATTRIBUTES OF IMAGES”, and from U.S. provisional patent No. 63/483,731, filed Feb. 7, 2023, entitled “METHODS AND SYSTEMS FOR GENERATING TEXT WITH TONE OR DICTION CORRESPONDING TO STYLISTIC ATTRIBUTES OF IMAGES” the entireties of which are hereby incorporated by reference.

### FIELD

The present disclosure is related to machine learning, and, more particularly, to generation of prompts to large language models (LLM), and, yet more particularly, to prompting the LLM to generate a description of an image with a tone of voice corresponding to visual attributes of the image.

### BACKGROUND

When presented with an image, one approach to text generation may be to output text that focuses on the literal subject matter. A generic narrative could also be provided (e.g., based on that literal subject matter). Such descriptions are not effective in communicating the style or emotion of the image, or the style or emotion of anything associated with the image, such as the webpage, the product, and/or other the accompanying text.

### SUMMARY

Describing images based on their literal subject matter may not accurately capture the nuance of the image or how the image may be perceived by a viewer. Accordingly, such a direct description may fall short. Rather, the more subtle visual aspects of an image naturally provide indications of the image's tone and emotion. This can be used to generate a more stylistically or tonally matching description. Thus, generating description text based on the subtle visual aspects of the image may better capture the nuance and essence of the image in a way perceptible by a reader.

In various examples, the present disclosure describes a technical solution that makes use of uniquely trained machine learning models to extract the visual attributes of an image, and further translates the visual attributes into voice or emotion attributes that can be used to prompt a LLM. This enables the same/similar voice or emotion attributes of images to be introduced into the generated description of the image. In this manner, the user input required to edit or further edit the caption to the desired emotional tone is reduced, thus requiring less computer processing and less memory usage to save user edits. The present systems and methods also enable a processor to perform a function (i.e. to generate emotionally or tonally appropriate and corresponding description for an image) that would otherwise require human skill.

In some examples, the present disclosure describes a computing system including: a processing unit configured to execute instructions to cause the system to: extract from an image, one or more visual attributes of the image, using a first trained machine learning model; map the one or more visual attributes to one or more emotion attributes, using a second trained machine learning model; generate a prompt to a large language model (LLM), the prompt being based on the one or more emotion attributes; provide the generated prompt to the LLM; and obtain, from the LLM, a generated description of the image.

In an example of the preceding system, the first trained machine learning model is a trained deep neural network.

In an example of the preceding systems, the second trained machine learning model is a trained neural network.

In an example of the preceding systems, the prompt includes at least one of the one or more emotion attributes.

In an example of the preceding systems, the processing unit is further configured to execute instructions to cause the system to store and display the generated description with the image.

In an example of the preceding systems, the processing unit is further configured to execute instructions to cause the system to incorporate a generic description of the image into the prompt.

In an example of the preceding systems, the processing unit is further configured to execute instructions to cause the system to retrieve the generic description of the object from a description database.

In an example of the preceding systems, the processing unit is further configured to execute instructions to cause the system to provide the image to a descriptor text generator to obtain the generic description for incorporation into the prompt.

In an example of the preceding systems, the image comprises an object.

In an example of the preceding systems, the generated prompt further comprises a name of the object in the image.

In an example of the preceding systems, the processing unit is further configured to execute instructions to cause the system to incorporate physical attributes of the object into the prompt.

In an example of the preceding systems, the processing unit is further configured to execute instructions to cause the system to retrieve the physical attributes of the object from an object attribute database.

In an example of the preceding systems, the visual attributes are extracted from multiple images of the object.

In an example of the preceding systems, the visual attributes are visual attributes that were common to each of the multiple images.

In an example of the preceding systems, the visual attributes are visual attributes that were the most commonly extracted from the multiple images.

In some examples, the present disclosure describes a computer-implemented method comprising extracting from an image, one or more visual attributes of the image, using a first trained machine learning model; mapping the one or more visual attributes to one or more emotion attributes, using a second trained machine learning model; generating a prompt to a large language model (LLM), the prompt being based on the one or more emotion attributes; providing the generated prompt to the LLM; and obtaining, from the LLM, a generated description of the image.

In an example of the preceding method, the first trained machine learning model is a trained deep neural network.

In an example of the preceding methods, the second trained machine learning model is a trained neural network.

In an example of the preceding methods, the method further includes storing and displaying the generated description with the image.

In an example of the preceding methods, generating the prompt comprises incorporating at least one of the one or more emotion attributes into the prompt.

In an example of the preceding methods, generating the prompt comprises incorporating a generic description of the image into the prompt.

In an example of the preceding methods, generating the prompt further comprises: retrieving the generic description of the object from a description database.

In an example of the preceding methods, generating the prompt further comprises: providing the image to a descriptor text generator to obtain the generic description.

In an example of the preceding methods, the image comprises an object.

In an example of the preceding methods, generating the prompt comprises incorporating a name of the object into the prompt.

In an example of the preceding methods, generating the prompt comprises incorporating physical attributes of the object into the prompt.

In an example of the preceding methods, the method further includes extracting the physical attributes of the object from an object attribute database.

In an example of the preceding methods, the visual attributes are extracted from multiple images of the object.

In an example of the preceding methods, the visual attributes are visual attributes that were common to each of the multiple images.

In an example of the preceding methods, the visual attributes are visual attributes that were the most commonly extracted from the multiple images.

In some examples, the present disclosure describes a computer-readable medium storing instructions that, when executed by a processor of a computing system, cause the computing system to extract from an image, one or more visual attributes of the image, using a first trained machine learning model; map the one or more visual attributes to one or more emotion attributes, using a second trained machine learning model; generate a prompt to a large language model (LLM), the prompt being based on the one or more emotion attributes; provide the generated prompt to the LLM; and obtain, from the LLM, a generated description of the image.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system including a prompt generation engine and a storage unit, which may be used to implement examples of the present disclosure;

FIG. 3 is a block diagram of the prompt generation engine and the storage unit of FIG. 2 shown in more detail;

FIG. 4 is a flowchart illustrating a method for generating stylistic image descriptions according to examples of the present disclosure;

FIG. 5 is a flowchart illustrating another method for generating stylistic image descriptions according to examples of the present disclosure;

FIG. 6 is a block diagram of an example e-commerce platform including the prompt generation engine of FIG. 2, which may be an example implementation of the examples disclosed herein;

FIG. 7 is an example homepage of an administrator, which may be accessed via the e-commerce platform of FIG. 6; and

FIG. 8 is another block diagram of the example e-commerce platform and the prompt generation engine of FIG. 6 showing details related to the prompt generation engine according to an embodiment.

Similar reference numerals may have been used in different figures to denote similar components.

### DETAILED DESCRIPTION

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

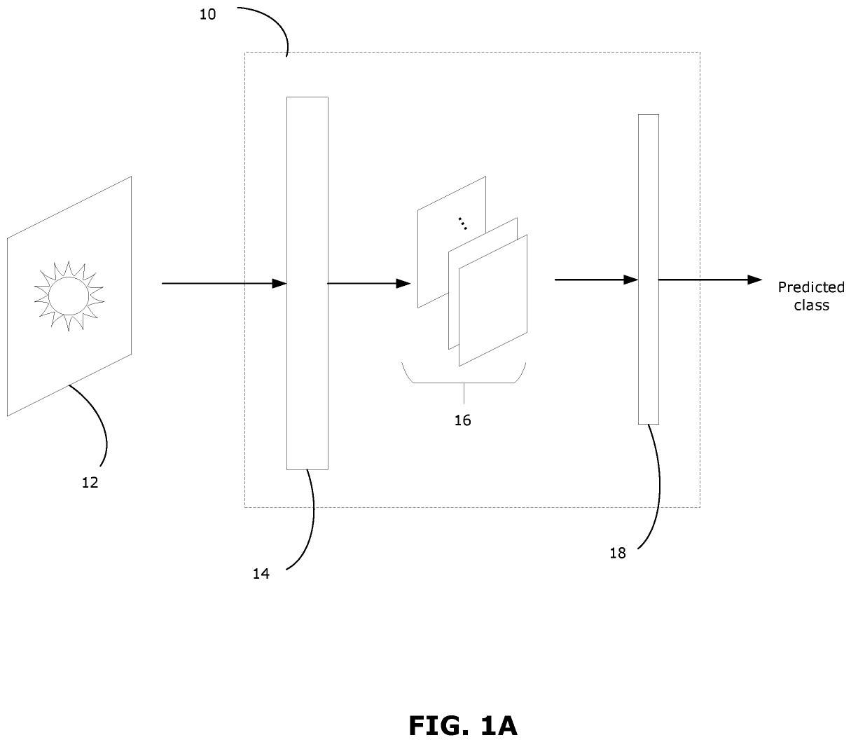

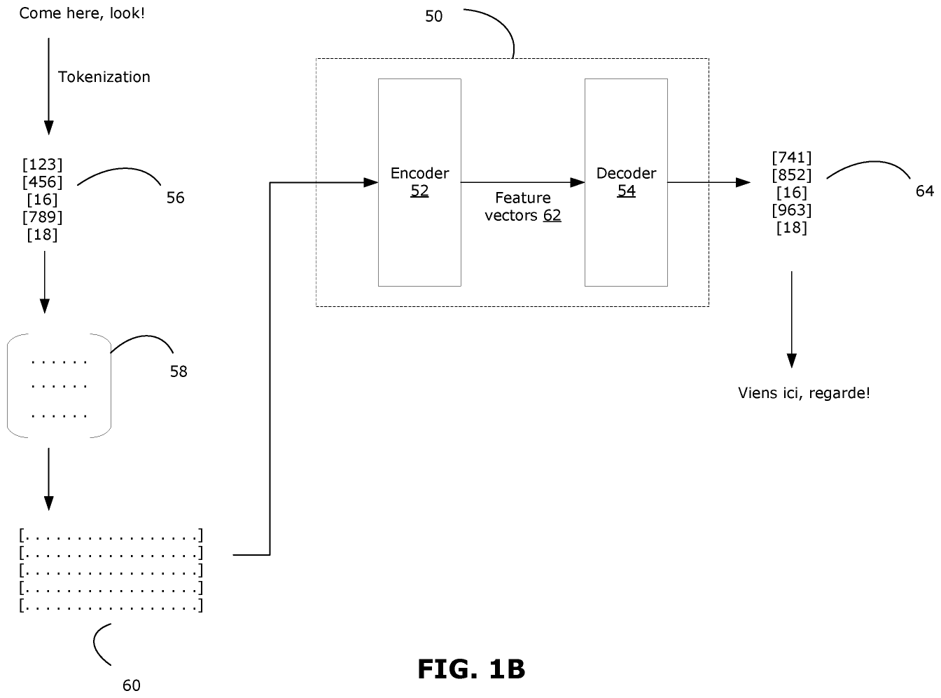

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

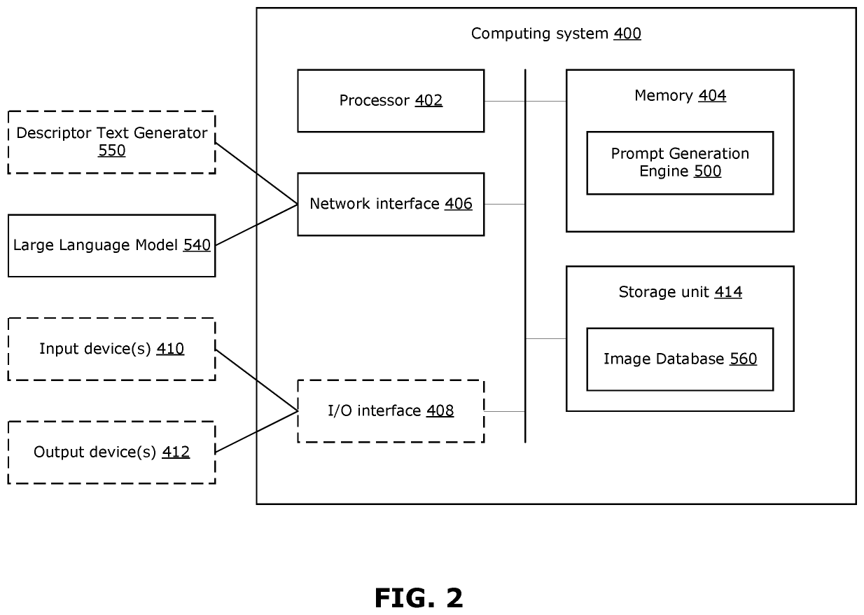

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

In the example of FIG. 2, the computing system 400 may store computer-executable instructions in the memory 404, which may be executed by a processing unit such as the processor 402, to implement one or more embodiments disclosed herein. For example, the memory 404 may store instructions for implementing prompt generation engine 500 and, optionally, descriptor text generator 550 applications. In some examples, the computing system 400 may be a server of an online platform that provides the prompt generation engine 500 and descriptor text generator 550 as web-based or cloud-based services that may be accessible by a user device (e.g., via communications over a wireless network). In some examples, the computing system 400 may be a user device that provides the prompt generation engine 500 as a software application while another embodiment of the computing system 400 may be a server of the online platform that provides the descriptor text generator 550. The descriptor text generator 550 may, alternatively, reside on a remote system that is external to the computing system 400 as shown in FIG. 2. In such a case, similar to the LLM 540, the computing system 400 may communicate with the descriptor text generator 550 using the network interface 406. Other such variations may be possible.

In the example shown, the computing system 400 may store, in a storage unit 414, an image database 560 storing a plurality of images 562 and data about the plurality of images 562. In that regard, the image database 560 may store the images 562 themselves, a user or account associated with the images 562, generic descriptions 564 of the images 562 etc. While the storage unit 414 is shown to be separate from the memory 404 in FIG. 2, in other applications, the storage unit 414 may form part of the memory 404, or the image database 560 may simply reside in the memory 404.

In applications where the images 562 are images of a subject or an object, the image database 560 may include, for each image, data about attributes related to the object (e.g., object name, object size, object type, object features, etc.). Object attribute(s) for a given object may, for example, be stored in a lookup table (such as an object attribute database 566) that can be referenced using the name of the object, a unique identifier (e.g., identification number) of the object, etc. The data stored in the object database 560 may be labeled by category. For example, each object may have at least an object attribute in the category [object name]. Additional object attributes may include attributes in categories such as [color], [owner], [size], etc. As an example, the object attribute database 566 may store the following object attributes related to a chair: [object name] “ergonomic chair”, [color] “black”, [material] “leather”. Each object attribute of a given object may be stored as a text string (which may include one or more words).

The image database 560 may be queried by, for example, the prompt generation engine 500 and/or the descriptor text generator 550, as discussed further below. In some examples, the image database 560 may not be stored locally on the computing system 400 but may instead be a remote database accessible by the computing system 400 (e.g., via a wired or wireless communication link, for example using the network interface 406).

Optionally, the image database 560 may store other data related to each image, such as generated stylistic image descriptions 568, as will be discussed in greater detail below.

In various examples, the present disclosure provides methods and systems for generating a stylistic description of an image, using a large language model (LLM), in a tone of voice and/or with diction that corresponds with the visual and emotional attributes of the image. The present disclosure makes use of uniquely trained machine learning (ML) models to extract the visual attributes of an image, and further to translate the visual attributes into voice or emotion attributes that can be used to prompt a LLM. This enables the same/similar voice or emotion attributes of images to be introduced into the generated description of the image.

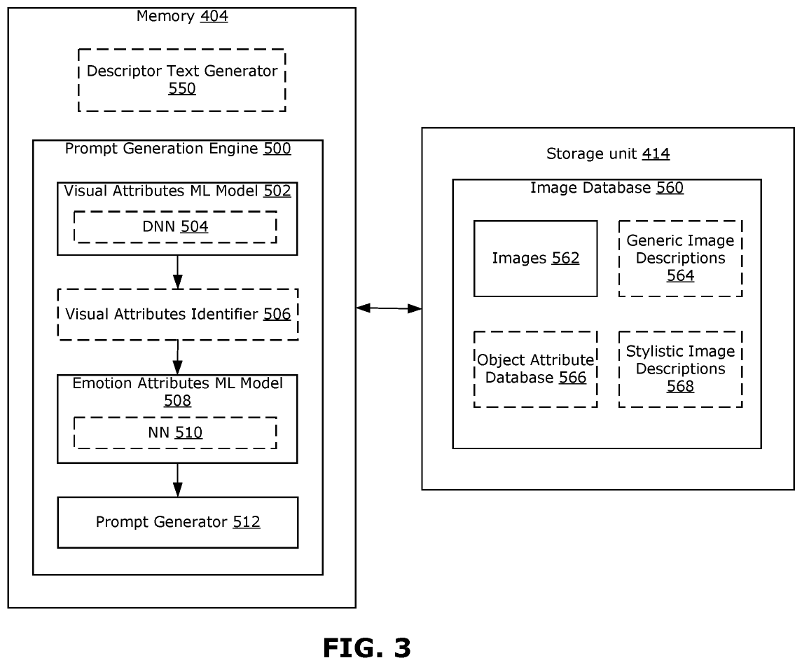

Turning to FIG. 3, there is illustrated the memory 404 and the storage unit 414 with greater detail according to an example embodiment. As illustrated, instructions for implementing the prompt generation engine 500 may be stored in the memory 404. Optionally, instructions for implementing the descriptor text generator 550 may also be stored in the memory 404. The prompt generation engine 500 is shown to comprise a first ML model, a second ML model, a prompt generator 512 and, optionally, a visual attributes identifier 506.

The first ML model is a ML model that has been trained to extract stylistic visual attributes from images, the first ML model also, thus, referred to as a visual attributes ML model 502. The visual attributes ML model 502 may be, for example, a trained neural network, a trained deep neural network (DNN), or a trained convolutional neural network (CNN) 504. The visual attributes ML model 502 may have been trained by having it process a set of images that have been labelled with the correct stylistic visual attributes. Stylistic visual attributes refer, herein, to qualities or characteristics of an image that can be visually observed and identified. Example visual attributes include quality of light (e.g., hard, soft, etc.), ISO or brightness level of the image, shutter speed (e.g., level of sharpness or blurriness), aperture or level of depth of field, composition (e.g., types of lines, shapes, forms, and/or their distribution in the image), color palette (such as monochromatic, light or dark colors, color intensity, RGB values, etc.) and textures, (e.g., smooth, shiny, hairy, etc.). In images that contain a subject or object, the stylistic visual attributes may further include the object's placement and/or size in the frame and the direction of light relative to the object.

Example images with which the visual attributes ML model 502 may be trained on could include a picture of a plush frog and a picture of a leather jacket. The plush frog image may be labelled with “soft lighting”, “round shapes”, “pastel palette”, and “fuzzy texture”, among others. The leather jacket image may be labelled with “strong contrast”, “hard lighting”, “dark palette”, and “shiny texture”, among others. Alternatively or additionally, some of the stylistic attributes may be expressed quantitatively, such as ISO, brightness level, shutter speed, aperture, color intensity, and RGB values. After the visual attributes ML model 502 has been trained, it should then be able to output correct stylistic visual attributes of a new image when the new image is inputted.

The visual attributes ML model 502 may be configured to provide instructions to the processor 402 to retrieve its input images (for visual attribute extraction) from the images 562 stored in the image database 560. Additionally or alternatively, the processor 402 may be instructed to receive the input image(s) via the I/O interface 408 from the input device 410. Other sources of the input image(s) known in the field are possible.

In applications where only one image is used, typically all the stylistic visual attributes extracted from the image by the visual attributes ML model 502 would be relevant for generating a corresponding description. However, in other applications, a description that corresponds to multiple images of the same subject or object may be desired. In such a case, the visual attributes ML model 502 may be used to process each of the multiple images individually to extract the stylistic visual attributes for each image. The visual attributes identifier 506 may then provide instructions to the processor 402 to identify the stylistic visual attributes that are common to all the images. Alternatively, the visual attributes identifier 506 may provide instructions to the processor 402 to identify the stylistic visual attributes that are most common to all the images. In further applications, the visual attributes identifier 506 may provide instructions to the processor 402 to identify the most relevant stylistic visual attributes based on a pre-set ranking of the visual attributes, other criteria, or logic rules.

In the depicted embodiment, the visual attributes identifier 506 is shown to be separate from the visual attributes ML model 502. However, in other examples, the visual attributes identifier 506 instructions may form part of the visual attributes ML model 502. In such a case, when processing multiple images of the same object, instead of outputting the visual attributes for each image, the visual attributes ML model 502 may output the most common or relevant visual attributes for all of the images.

The prompt generation engine 500 also comprises the second ML model. The second ML model has been trained to translate or map the extracted stylistic visual attributes (from the visual attributes ML model 502) to corresponding tone of voice or emotion attributes. Thus, the second ML model is referred to herein as an emotion attributes ML model 508. The emotion attributes ML model 508 may be another trained neural network 510. The emotion attributes ML model 508 may have been trained by having it process a dataset of stylistic visual attributes that have been previously associated with corresponding one or more tone of voice or emotion attributes. Emotion attributes refer, herein, to the manner and/or sentiment that is conveyed in text.

The types of tone of voice or emotion attributes that the stylistic visual attribute training data may be pre-labelled with might include, for example:
Casual
Humorous
Serious
Playful
Sensual
Rebellious
Gentle
Quirky
Daring
Expert
Professional
Persuasive
Sophisticated
Luxurious
Supportive
Straightforward
Minimalistic

Example training data with which the emotion attributes ML model 508 may be trained on could include: “soft lighting”, “round shapes”, “pastel palette”, and “fuzzy texture” (visual attributes), which could be labelled with, or mapped to, “supportive” and “gentle” (emotion attributes). “Strong contrast”, “hard lighting”, “dark palette”, and “shiny texture” (visual attributes) may be labelled with, or mapped to, “daring” and “rebellious” (emotion attributes). After the emotion attributes ML model 508 has been trained, it should then be able to output the tone of voice or emotion attributes that appropriately correspond to the (combination of) inputted stylistic visual attributes.

Since visual attributes can have different emotional associations or meanings in different cultures, the stylistic visual attribute training data may be selected or tailored to culturally match the target description reading audience. In that manner, the emotion attributes ML model 508 may be trained on different training data depending on who the target end user will be.

After the emotion attributes ML model 508 has been trained and has outputted the one or more emotion attributes in response to the inputted visual attributes of the corresponding image(s), the prompt generator 512 is configured to provide instructions to the processor 402 to generate a prompt based on the one or more emotion attributes for a LLM. In some examples, the prompt generator 512 may be configured to provide instructions to the processor 402 to generate a prompt that includes at least one of the emotion attributes.

In other applications, the prompt generator 512 may provide instructions to the processor 402 to generate a prompt that includes a link to the original image (or an associated image), received, e.g., via the input device 410 and the I/O interface 408.

Additionally or alternatively, the prompt generator 512 may provide instructions to the processor 402 to generate a prompt based on the one or more emotion attributes, and may also include, or be based on, a generic description of the original image. If the generic image description 564 is stored in the image database 560, the prompt generator 512 may provide instructions to the processor 402 to query the image database 560 to retrieve the generic image description 564 of the original image from the image database 560, for example. In other examples, the prompt generator 512 may provide instructions to the processor 402 to provide the original image to the descriptor text generator 550 (which may be remote or implemented locally by the processor 402) to obtain a generic, generated description of the image that lacks an emotional voice. The prompt generator 512 may then further instruct the processor 402 to incorporate the generic generated description into the prompt.

Additionally or alternatively, the prompt generator 512 may provide instructions to the processor 402 to generate the prompt with additional information relating to the subject or object in the image. Such additional information may include a name of the subject or object, and other attributes (including physical attributes) of the subject or object. To that end, the prompt generator 512 may provide instructions to the processor 402 to query the image database 560 to retrieve the additional information relating to the subject or object from the object attribute database 566. For example, the following information may be included in the prompt to generate a stylistic description for an image of a chair: [object name] “ergonomic chair”, [color] “black”, [material] “leather”.

In some applications, the prompt generator 512 may provide instructions to the processor 402 to send a query (optionally along with the original image) to the user, via the output device 412 and I/O interface 408 for example, to obtain the additional information relating to the subject or object in the image. The prompt generator 512 may then provide instructions to the processor 402 to generate the prompt with the additional information received via the input device 410.

The prompt generation engine 500 may provide instructions to the processor 402 to input the generated prompt into the LLM 540 via the network interface 406 to auto-generate a stylistic description 568 of the image based on the one or more emotion attributes. Examples of LLMs that may be used in this application include Transformer-XL, GPT-3 and ChatGPT.

The prompt generation engine 500 may then provide instructions to the processor 402 to receive the stylistic image descriptions 568 from the LLM and store the stylistic image descriptions 568 in the image database 560 associated with the original corresponding image(s) 562. In the case of images of objects, the LLM may auto-generate a stylistic object description for the given object to accompany the original input object images for display later on.

The present system makes use of uniquely trained machine learning models to extract the visual attributes of an image, and further to translate the visual attributes into voice or emotion attributes that can be used to prompt a LLM. This enables the same/similar voice or emotion attributes of images to be introduced into the generated stylistic description of the image. In this manner, the user input required to edit or further edit the caption to the desired emotional tone is reduced, thus requiring less computer processing and less memory usage to save user edits. The present system also enables a processor to perform a function (i.e. to generate emotionally or tonally appropriate and corresponding description for an image) that would otherwise require human skill.

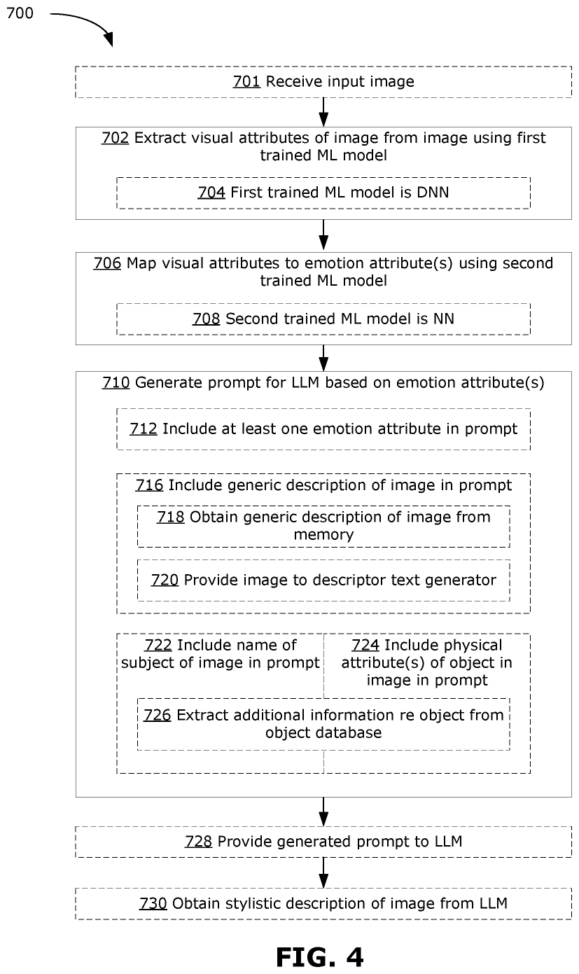

FIG. 4 is a flowchart of an example method 700 which may be performed by a computing system, in accordance with examples of the present disclosure. For example, a processing unit of a computing system (e.g., the processor 402 of the computing system 400 of FIG. 2) may execute instructions (e.g., instructions of the prompt generation engine 500 and/or the descriptor text generator 550) to cause the computing system to carry out the example method 700. The method 700 may, for example, be implemented by an online platform or a server.

At an operation 701, an input image is first retrieved from memory, such as from the image database 560, and/or received from an input device, such as the input device 410 via the I/O interface 408.

At an operation 702, the first trained ML model of the prompt generation engine 500 extracts one or more visual attributes of the input image from the input image. Such a trained ML model may be the visual attributes ML model 502. In some applications, at 704, the first trained visual attributes ML model may be a trained DNN or a trained CNN.

Stylistic visual attributes refer, herein, to qualities or characteristics of an image that can be visually observed and identified. Example visual attributes include quality of light (e.g., hard, soft, etc.), ISO or brightness level of the image, shutter speed (e.g., level of sharpness or blurriness), aperture or level of depth of field, composition (e.g., types of lines, shapes, forms, and/or their distribution in the image), color palette (such as monochromatic, light or dark colors, color intensity, RGB values, etc.) and textures, (e.g., smooth, shiny, hairy, etc.). In images that contain a subject or object, the stylistic visual attributes may further include the object's placement and/or size in the frame and the direction of light relative to the object. The first trained ML model is trained to determine or identify one or more of these stylistic visual attributes of, and from, the input image.

The extracted one or more visual attributes of the input image may be expressed or outputted by the first trained ML model as labels, such as “soft lighting”, “round shapes”, “pastel palette”, and “fuzzy texture”, among others. Alternatively or additionally, some of the stylistic attributes may be expressed or outputted by the first trained ML model quantitatively, such as ISO, brightness level, shutter speed, aperture, color intensity, and RGB values.

At an operation 706, the second trained ML model of the prompt generation engine 500 translates or maps the one or more extracted visual attributes, from the first trained ML model, to corresponding emotion attributes. Such a trained ML model may be the emotion attributes ML model 508. In some applications, at 708, the second trained emotion attributes ML model may be another trained neural network.

Emotion attributes or tone of voice refer, herein, to the manner and/or sentiment that is conveyed in text. The second trained ML model is trained to translate or map the stylistic visual attributes from the first trained ML model to corresponding emotion attributes or tone of voice.

The types of tone of voice or emotion attributes that can be conveyed in text might include, for example, Casual, Humorous, Serious, Playful, Sensual, Rebellious, Gentle, Quirky, Daring, Expert, Professional, Persuasive, Sophisticated, Luxurious, Supportive, Straightforward, and Minimalistic. For example, the second trained ML model may thus be configured to translate or map visual attributes, such as “soft lighting”, “round shapes”, “pastel palette”, and “fuzzy texture”, to corresponding tone of voice or emotion attributes, such as “gentle” and “playful”.

After the second trained ML model has outputted the one or more emotion attributes in response to the inputted visual attributes of the corresponding image(s), at an operation 710, a prompt for the LLM is generated based on the one or more emotion attributes. At an operation 712, the prompt may be generated to include at least one of the emotion attributes, e.g., as text. In some applications, the prompt may be generated to include a link to the original image (or an associated image), received, e.g., via the input device 410 and the I/O interface 408.

At an operation 716, the prompt may be generated to include a generic description of the original image. To that end, at an operation 718, the generic description of the original image may be retrieved from memory, such as from the image database 650. In other applications, at an operation 720, the generic description of the original image may be generated by a text generator. This may be accomplished, for example, by providing the original image to the text generator, such as the descriptor text generator 550, which is configured to receive and process the image, then output a generic description of the image. This generic description may then be incorporated into the LLM prompt, along with the emotion attribute(s).

Additionally or alternatively, further information related to the subject or object in the image may be included in the LLM prompt. At an operation 722, the prompt may be generated to include a name of the subject or object. At an operation 724, the prompt may be generated to include other attributes (including physical attributes) of the subject or object. In some embodiments, the name and/or other attributes, if included, may be an output (or otherwise derived from an output) of the first trained ML model.

At an operation 726, the additional information (such as the name and/or physical attributes) may be extracted from a database, such as the image database 560. For example, the following information may be included in the prompt to generate a stylistic description for an image of a chair: [object name]“ergonomic chair”, [color] “black”, [material] “leather”. In such a case, the prompt may be: “Write a description, using a professional and luxurious tone, of a black leather ergonomic chair”.

After the prompt has been generated, at an operation 728, the generated prompt may be provided to the LLM. For example, the generated prompt may be provided to the LLM via the network interface 406. The LLM then auto-generates a stylistic description of the image. Examples of LLMs that may be used in this application include Transformer-XL, GPT-3 and ChatGPT.

At an operation 730, the stylistic description of the image is then obtained from the LLM. The stylistic description of the image may be saved in memory, such as stored in the image database 560 in association with the original corresponding image. The stylistic description of and the original image may subsequently be displayed together.

In applications where only one image is used, typically all the stylistic visual attributes extracted from the image by the first trained ML model would be relevant for generating a corresponding description. However, in other applications, a description that corresponds to multiple images of the same subject or object may be desired.

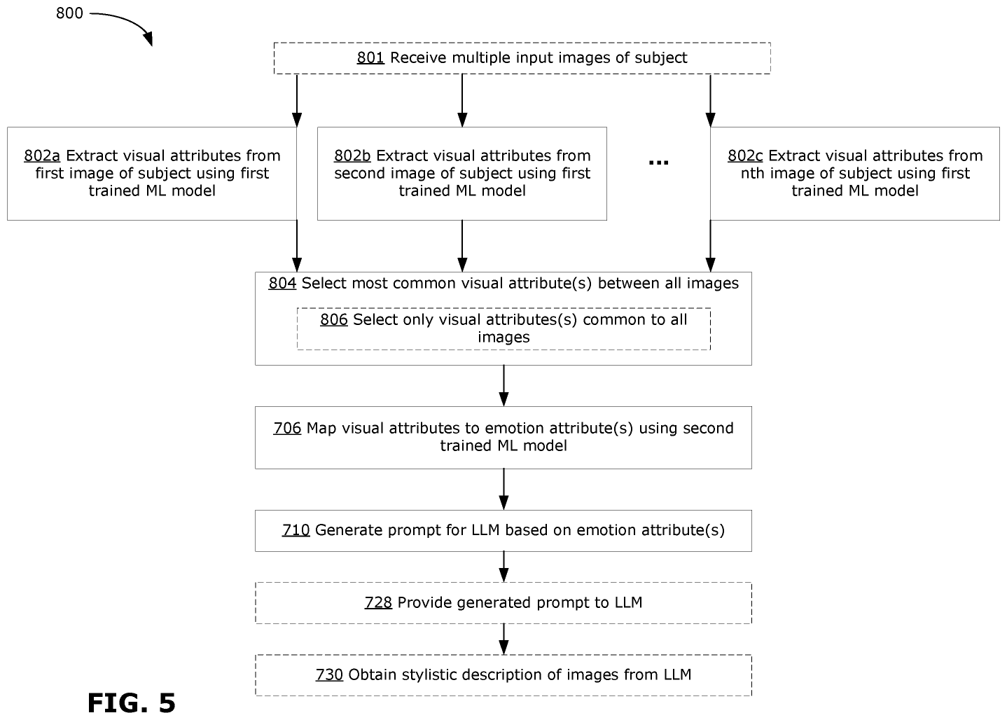

FIG. 5 is a flowchart of an example method 800 which may be performed by a computing system, in accordance with examples of the present disclosure. The method 800 is a variation of method 700, where multiple images of the subject or object are processed. Method 800 may also be implemented by an online platform or a server.

Similar to 701, at an operation 801, multiple input images of an object or subject are first retrieved from memory, such as from the image database 560, and/or received from an input device, such as the input device 410 via the I/O interface 408.

At an operation 802a, 802b, 802c etc., the first trained visual attributes ML model processes each of the multiple images individually as described above to extract the stylistic visual attributes for each image.

At an operation 804, the visual attributes of all the images are compared and the most common visual attributes between all the processed images are identified and selected, such as by the visual attributes identifier 506. For example, if the visual attribute “soft lighting” was extracted from four images and “hard lighting” was extracted from one image, the visual attributes identifier 506 may select “soft lighting” for further processing.

Optionally, at an operation 806, only the visual attributes that are common to all of the processed images (i.e. only visual attributes that are present in all of the processed images) may be identified and selected by the visual attributes identifier 506. In other applications, the most relevant stylistic visual attributes may be identified and selected based on a pre-set ranking of the visual attributes, other criteria, or logic rules.

After the most common and/or relevant visual attributes have been selected, at the operation 706, they are inputted into the second trained ML model for further processing as described above. The operation 706 outputs the corresponding one or more emotion attributes, and a LLM prompt is generated at the operation 710 based on at least one of the one or more emotion attributes, also as described above. In the event a generic description is to be generated by the descriptor text generator 550 for the LLM prompt, a representative one of the multiple original images may be provided to the descriptor text generator 550 to generate the generic description.

After the prompt has been generated, at the operation 728, the generated prompt may be provided to the LLM, such as via the network interface 406. At the operation 730, the stylistic description of the images is then obtained from the LLM. The stylistic description of the images may be saved in memory, such as stored in the image database 560 in association with the original corresponding images. The stylistic description and the original images may subsequently be displayed together.

As noted above, the present method makes use of uniquely trained machine learning models to extract the visual attributes of an image, and further to translate the visual attributes into voice or emotion attributes that can be used to prompt a LLM. This enables the same/similar voice or emotion attributes of images to be introduced into the generated stylistic description of the image. In this manner, the user input required to edit or further edit the caption to the desired emotional tone is reduced, thus requiring less computer processing and less memory usage to save user edits. The present method also enables a processor to perform a function (i.e. to generate emotionally or tonally appropriate and corresponding description for an image) that would otherwise require human skill.

The present methods and systems may be used in a variety of applications, commerce being one such application.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

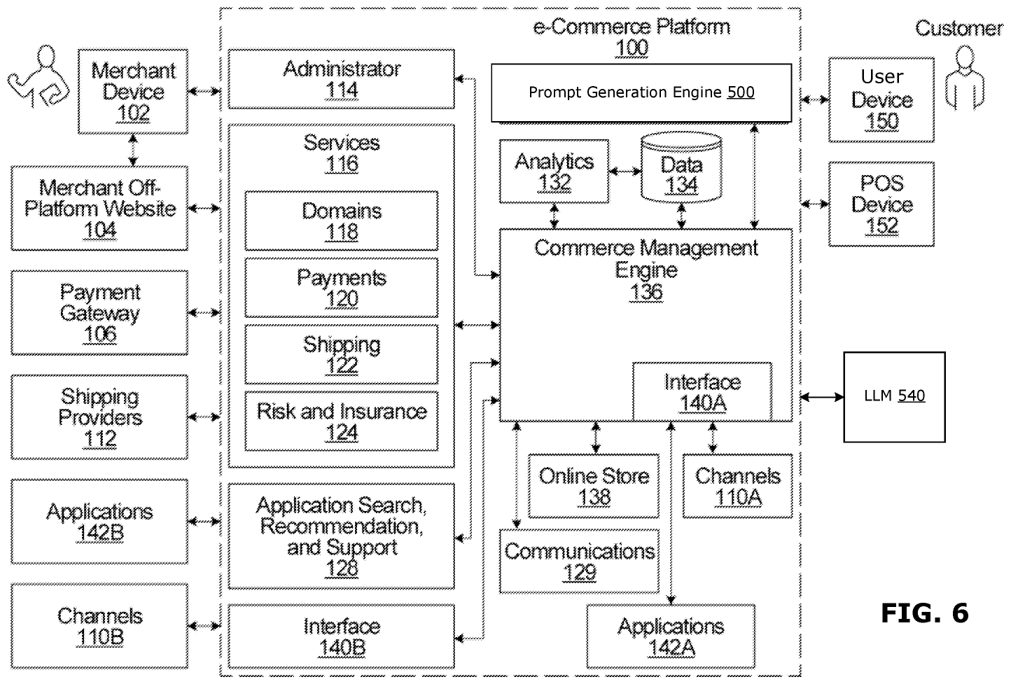

FIG. 6 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 6, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

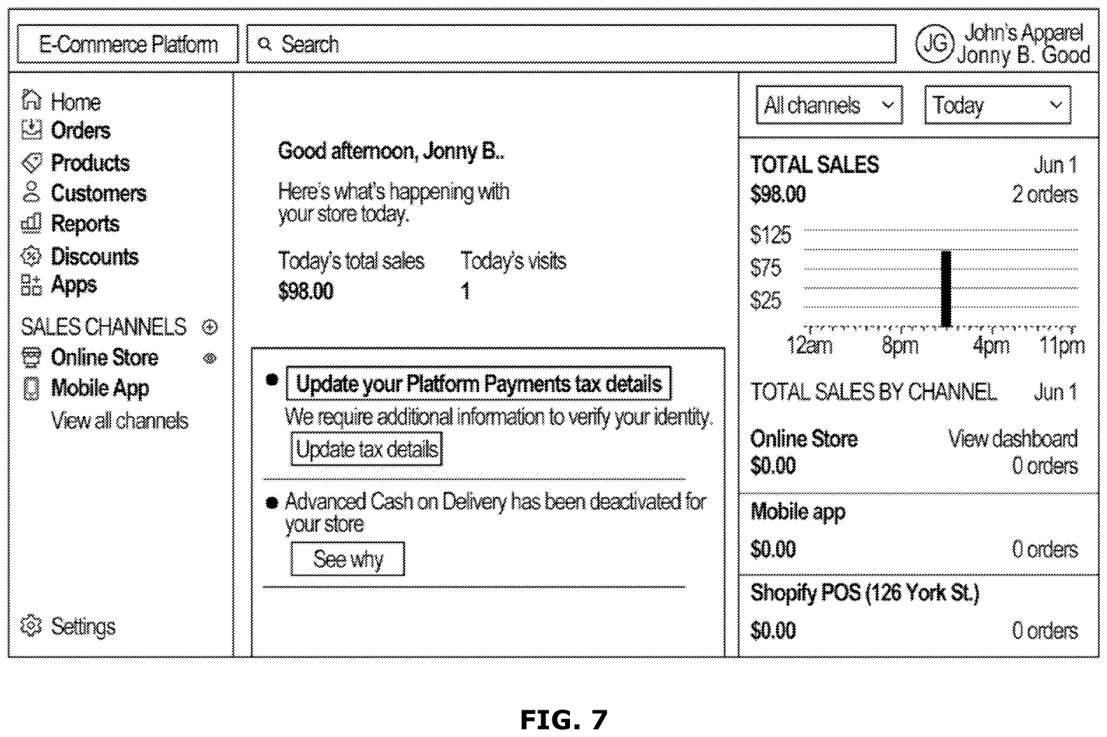

FIG. 7 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 3. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 2, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

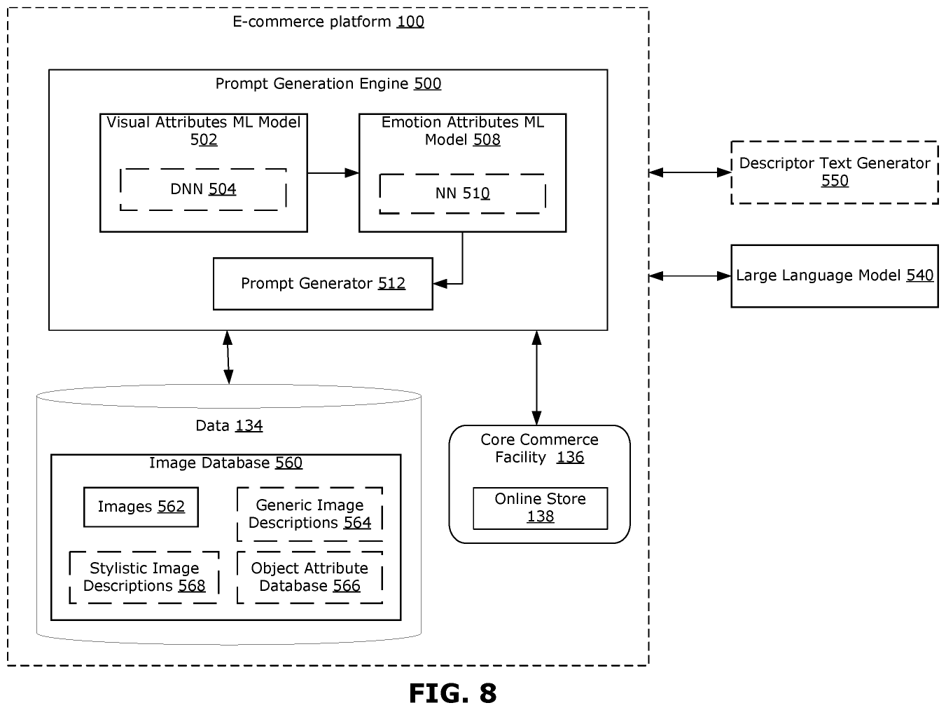

Having discussed an example e-commerce platform, the prompt generation engine 500 and the image database 560 as disclosed herein may be implemented on the e-commerce platform 100 to enable more efficient use of resources by the e-commerce platform, for example, as shown in FIG. 8. In the depicted implementation, the prompt generation engine 500 may be in communication with the core commerce facility 136, and the image database 560 may be stored within data 134.

In commerce applications, products offered for sale are typically represented by images (e.g., photographs) of the product along with a description of the product. Many merchants already spend a great deal of resources in acquiring excellent product images that visually express the tone and emotion that would appeal to their target customer. Often their products are professionally photographed. Copy writers are also often hired in order to write product descriptions styled and focused on the desires of those potential customers. However, copy writers are often expensive, especially if the merchant has an extensive product catalog, thus increasing marketing costs.

Alternatively, there currently exists software that enables descriptor text generation, such as screen readers, which can translate an image into text. However, as noted above, screen readers typically tend to focus on the physical product itself, resulting in generic and non-emotive descriptions. Such descriptions lack a stylistic voice and are not effective in communicating the style or emotion of the corresponding image.

Consequently, merchants can use the present systems and methods to generate more appropriate product descriptions faster and at a lower cost, while also maintaining or improving on their conversion rates.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system comprising:
a processing unit configured to execute instructions to cause the system to:
extract, from an image, one or more visual attributes of the image using a first trained machine learning model;
map the one or more visual attributes to one or more emotion attributes using a second trained machine learning model;
generate a prompt to a large language model (LLM), the prompt being based on the one or more emotion attributes;
provide the generated prompt to the LLM; and
obtain, from the LLM, a generated description of the image.

2. The system of claim 1, wherein the first trained machine learning model is a trained deep neural network.

3. The system of claim 2, wherein the second trained machine learning model is a trained neural network.

4. The system of claim 1, wherein the prompt includes at least one of the one or more emotion attributes.

5. The system of claim 1, wherein the processing unit is further configured to execute instructions to cause the system to incorporate a generic description of the image into the prompt.

6. The system of claim 5, wherein the processing unit is further configured to execute instructions to cause the system to retrieve the generic description of the object from a description database.

7. The system of claim 5, wherein the processing unit is further configured to execute instructions to cause the system to provide the image to a descriptor text generator to obtain the generic description for incorporation into the prompt.

8. The system of claim 1, wherein the image comprises an object.

9. The system of claim 8, wherein the generated prompt further comprises a name of the object in the image.

10. The system of claim 8, wherein the processing unit is further configured to execute instructions to cause the system to incorporate physical attributes of the object into the prompt.

11. The system of claim 8, wherein the visual attributes are extracted from multiple images of the object.

12. The system of claim 11, wherein the visual attributes are visual attributes that were common to each of the multiple images.

13. A computer-implemented method comprising:
extracting, from an image, one or more visual attributes of the image using a first trained machine learning model;
mapping the one or more visual attributes to one or more emotion attributes using a second trained machine learning model;
generating a prompt to a large language model (LLM), the prompt being based on the one or more emotion attributes;
providing the generated prompt to the LLM; and
obtaining, from the LLM, a generated description of the image.

14. The method of claim 13, wherein the first trained machine learning model is a trained deep neural network.

15. The system of claim 14, wherein the second trained machine learning model is a trained neural network.

16. The method of claim 15, wherein generating the prompt comprises incorporating at least one of the one or more emotion attributes into the prompt.

17. The method of claim 16, wherein generating the prompt comprises incorporating a generic description of the image into the prompt.

18. The method of claim 17, wherein generating the prompt further comprises: retrieving the generic description of the object from a description database.

19. The method of claim 17, wherein generating the prompt further comprises: providing the image to a descriptor text generator to obtain the generic description.

20. The method of claim 15, wherein the image comprises an object.

21. The method of claim 20, wherein generating the prompt comprises incorporating physical attributes of the object into the prompt.

22. The method of claim 21, further comprising: extracting the physical attributes of the object from an object attribute database.

23. The method of claim 20, wherein the visual attributes are extracted from multiple images of the object.

24. The method of claim 23, wherein the visual attributes are visual attributes that were the most commonly extracted from the multiple images.

25. A non-transitory computer-readable medium storing instructions that, when executed by a processor of a system, causes the system to:
extract, from an image, one or more visual attributes of the image using a first trained machine learning model;
map the one or more visual attributes to one or more emotion attributes using a second trained machine learning model;
generate a prompt to a large language model (LLM), the prompt being based on the one or more emotion attributes;
provide the generated prompt to the LLM; and
obtain, from the LLM, a generated description of the image.
